(19) United States
(12) Patent Application Publication
(10) Pub. No.: US 2016/0093947 A1
(43) Pub. Date: Mar. 31, 2016

(54) Flat Spiral Antenna for Utility Meter Reporting Systems and Other Applications

(71) Applicant: Yoram Kenig, Horsham, PA (US)

(72) Inventor: Yoram Kenig, Horsham, PA (US)

(21) Appl. No.: 14/608,449

(22) Filed: Jan. 29, 2015

Related U.S. Application Data
(63) Continuation-in-part of application No. 14/497,628, filed on Sep. 26, 2014.

(51) Int. Cl. H01Q 1/36; H01Q 1/14

(52) U.S. Cl. CPC H01Q 1/36; H01Q 1/14

(57) ABSTRACT

A new Flat Spiral VHF Antenna (FSVA) transmits circularly polarized RF transmissions only. The spiral antenna transmits from circular components only, forgoing transmission from any vertical or horizontal component. The spiral antenna may be integrated into an integrated antenna cover which fits into the top cover of a pit housing. The antenna cover and/or upper lip area of the upper lip of the main housing may comprise a distal barrier and a medial barrier used to exclude water and contaminates. Disclosed transmission systems offer high output and low power consumption and vitiate the need for meter readers to physically access a water meter or other meters.

### CROSS-REFERENCE TO RELATED APPLICATIONS

This application is a continuation in part of application Ser. No. 14/497,628 filed on Sep. 26, 2014, the contents of which are herein incorporated by reference.

### BACKGROUND OF THE INVENTION

(1) Field of the Invention

The invention generally relates to flat spiral antenna systems. More particularly, the invention relates to means and methods of creating flat spiral antenna systems for use in high output integrated utility meter reporting systems.

(2) Description of the Related Art

Other spiral antenna systems are know in the related art. For example, U.S. Pat. No. 8,624,794 issued on Jan. 7, 2014 to Alexopoulous et al discloses a poly interwoven spiral antenna. U.S. Pat. No. 7,639,203 issued on Dec. 29, 2009 to Hao discloses a spiral coiled antenna. U.S. Pat. No. 7,586,462 issued on Sep. 8, 2009 to Tetorka discloses a dual head spiral antenna system. Unfortunately, the known prior art fails to provide significant improvements to the art. The known prior art faces a shortfall of using vertical and/or horizontal components in the transmission of RF.

Other wireless utility meter reporting systems are known in the related art. For example, Neptune Solutions produces multi-piece meter reporting systems. But, the known prior art fails to disclose or anticipate single integrated reporting units that are compact and able to transmit information to a distant centralized billing or information center. The related art places electronic components outside of pit vaults, subjecting the electronic components to damage inherent in outdoor environments. Thus, there is room in the art for the disclosed embodiments.

### BRIEF SUMMARY OF THE INVENTION

The disclosed antenna system overcomes shortfalls in the related art transmitting RF or radio frequency from the spiral components only, thus achieving and transmitting circular polarization only. The disclosed circular polarization achieves new efficiencies and surpasses prior performance standards.

In the related art, other spiral antenna emits radio frequency radiation from their vertical and horizontal components, generating a relatively inefficient transmission pattern.

The disclosed flat spiral antenna system is sometimes referred to as a Flat Spiral VHF Antenna or “FSVA” and is sometimes used in an Advanced Meter Infrastructure (AMI) application wherein the disclosed flat spiral antenna system emits RF radiation from a top surface of a Meter Transmitter Unit (MIT).

The disclosed flat spiral antenna system overcomes shortfalls of the prior art by use of an embodiment wherein a metal disc is mounted under the antenna below a plastic spacer. This disclosed configuration provides a unique advantage wherein an increase in frequency allows or requires an increase in antenna length. This is an advantage over the prior art wherein the length of an antenna decreases as the frequency increases.

The presently disclosed embodiments overcome shortfalls in the related art by presenting an unobvious and unique combination and configuration of methods and components to construct a integrated utility meter reporting system in an optimal position within a pit vault.

The invention overcomes shortfalls in the related art by providing internal shield systems to facilitate the compact nature of the disclosed embodiments.

Embodiments of the invention may also include the use of an antenna assembly integrated into the top portion of a vault or pit. The integrated antenna assembly allows for direct communication between the antenna and utility meter while placing the antenna superior to the vault such that the vault is sealed within the antenna but yet the antenna is positioned for maximum transmission range.

Disclosed embodiments use a new integrated antenna cover, spiral antenna, antenna insulator, support disk, an upper lip area of a main housing and other components to artfully seal and position an antenna within a top cover of a pit housing. Medial and lateral walls within the integrated antenna cover and other components keep weather out but yet fully support the antenna position within the pit cover. The integrated antenna cover and other components help to keep the entire unit within the vault or meter pit, adding the efficiency of the system.

Disclosed embodiments overcome shortfalls in the art by use of unique wireless transmission methods that compare incoming transmissions with prior transmissions. If an incoming transmission is identical to a previous transmission, the transmission is terminated, thus reducing energy usage and increasing battery life. The disclosed embodiments are conducive to use of high power transmitters of approximately five watts with an approximate range of three miles. The configurations of the known prior art are adapted for 0.05 watts with a maximum range of one mile.

In general, disclosed embodiments include meter reading systems that wirelessly transmit data to repeaters or central receiving units. Transmitted meter readings may be used for billing purposes and/or investigation of utility breakages or other problems.

These and other objects and advantages will be made apparent when considering the following detailed specification when taken in conjunction with the drawings.

### BRIEF DESCRIPTION OF THE DRAWINGS

FIG. 1 depicts a schematic view of a disclosed embodiment

FIG. 2 depicts a perspective view of an integrated meter system deployed within a pit

FIG. 3 depicts a sectional view of a disclosed embodiment

FIG. 4 depicts an elevation view of a disclosed integrated antenna system

FIG. 5 depicts a sectional view of FIG. 4

FIG. 6 depicts an exploded view of a disclosed system

FIG. 7 depicts upper assembly components

FIG. 8 depicts a plan view of a support disk

FIG. 9 depicts a plan view of a spiral antenna placed upon an antenna insulator

FIG. 10 depicts an elevation view of a disclosed antenna system

FIG. 11 depicts a perspective view of a partially disassembled antenna system

FIG. 12 depicts a perspective view of a disclosed RF transmission pattern

FIG. 13 depicts a wave form and other information regarding electromagnetically short antennas.

FIG. 14 depicts a perspective view of a disclosed circular polarization of RF

FIG. 15 depicts a plan view of a disclosed circular polarization pattern at a phase of zero degrees

FIG. 16 depicts a plan view of a disclosed circular polarization at a phase of 45 degrees

FIG. 17 depicts a plan view of a disclosed circular polarization at a phase of 90 degrees

FIG. 18 depicts a plan view of a disclosed circular polarization at a phase of 135 degrees

FIG. 19 depicts a plan view of a disclosed circular polarization at a phase of 180 degrees

FIG. 20 depicts a plan view of a disclosed circular polarization at a phase of 180 degrees

FIG. 21 depicts a plan view of a disclosed circular polarization at a phase of 270 degrees

FIG. 22 depicts a plan view of a disclosed circular polarization at a phase of 360 degrees

### REFERENCE NUMERALS IN THE DRAWINGS

100 a disclosed system in general
200 pit housing or vault in general
205 top cover of pit housing 200
210 side wall of pit housing 200
215 bottom wall of pit housing 200
300 a transmitter assembly or antenna system
304 optional internal divots of integrated antenna cover
305 integrated antenna cover
306 medial barrier of antenna cover
307 distal barrier of antenna cover
310 spiral antenna
315 antenna insulator
317 spiral voids within the antenna insulator
318 spiral protrusions of the antenna insulator
320 support disk
321 center void of support disk
325 board for electronics or electronics board
326 connector for antenna
327 battery pack of board for electronics 325
328 horizontal index tab of electronics board 325
329 vertical index tab of electronics board 325
330 main housing
331 outer threaded area of main housing 330
332 upper lip area of main housing 330
333 medial wall of upper lip area 332 of main housing
334 lateral wall of upper lip area 332
335 antenna support shelf of main housing 330
336 center void of antenna support shelf 335
350 installation nut
351 internal female threads of installation nut
360 cable or electrical wire from water meter to electronics board 325
400 an empty housing
500 shield components
600 inflow pipe or lateral pipe from water main
605 outflow pipe to home or the consumer of water
700 external casing containing water meter between inflow pipe 600 and outflow pipe 605
800 a disclosed RF emission pattern of circular polarization
810 a wave pattern of electromagnetically short antennas
820 a disclosed RF emission pattern of circular polarization
822 a first concentric circle pattern of RF transmission
824 a second concentric circle pattern of RF transmission
826 a third concentric circle pattern of RF transmission
830 a perspective guide shown in the form of an viewer's eye
840 the view field or view port of a screen

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines

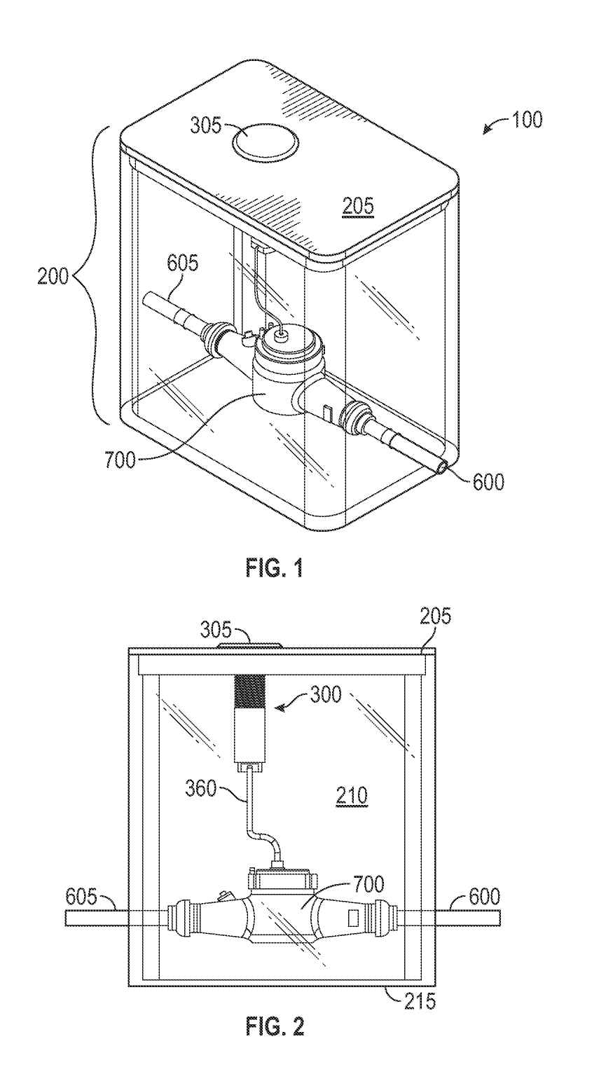

FIG. 1 depicts a disclosed system 100 in general which may comprise a pit housing or vault 200 containing an external casing 700 containing a water meter, the water meter positioned between an inflow pipe 600 and an outflow pipe 605. An integrated antenna cover 305 is shown disposed, within or integrated into a top cover 205 of the pit housing 200.

FIG. 2 depicts a side view of a pit housing having a front side wall 210 drawn as transparent. The pit is shown to contain an external casing 700, the external casing attached between an inflow pipe 600 and an outflow pipe 605. The enteral casing may contain a water meter or other type of meter. A cable 360 or other electrical wire is connected to the water meter and the transmitter assembly 300. The transmitter assembly is sometimes referred to as an integrated antenna system. A transmitter assembly or integrated antenna system may include an integrated antenna cover 305 and attached antenna components affixed or integrated into a top cover 205 of a housing pit.

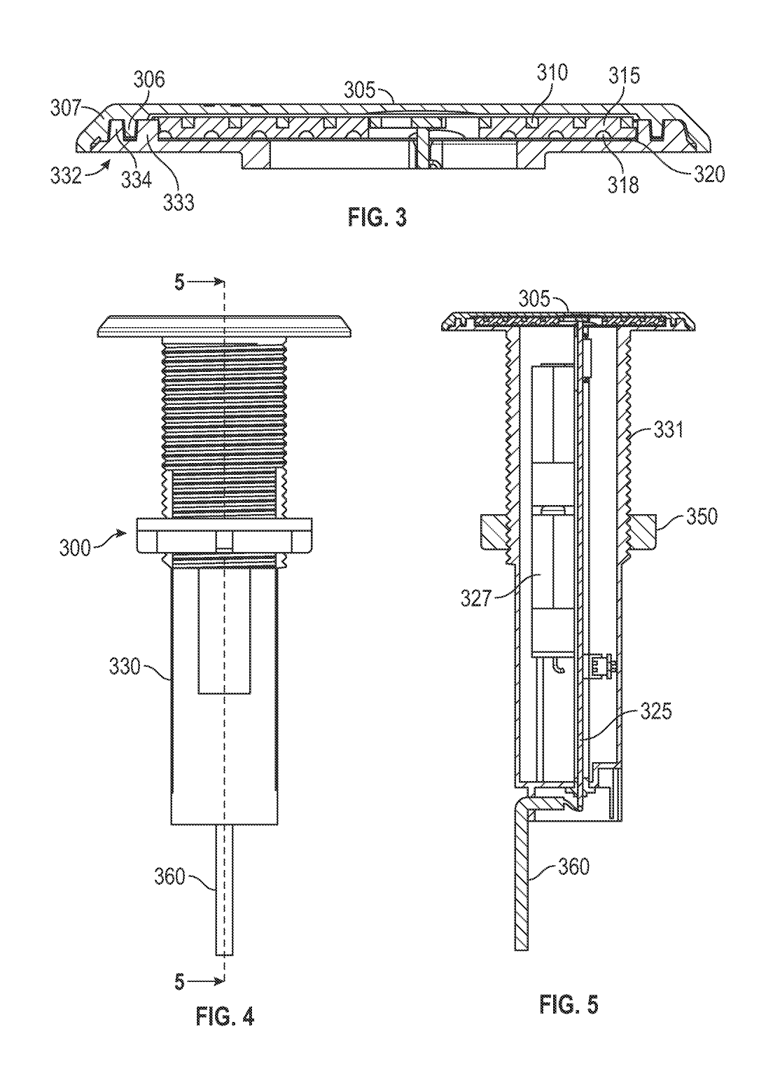

FIG. 3 depicts a sectional view of various antenna components, including an integrated antenna cover 305, spiral antenna 310, antenna insulator and antenna insulator 315. An integrated antenna cover may comprise a distal barrier 307 and medial barrier 306. An antenna insulator 315 may comprise spiral voids 317 defined by spiral protrusions 318. A main housing may comprise an upper lip area 332 which may comprise a medial wall 333 and a lateral wall 334. These various upper end antenna components help to secure the spiral antenna 310 within and/or above the superior section of a housing assembly and/or top cover 205 of a pit housing.

FIG. 4 depicts a transmitter assembly 300 in general and cable 360.

FIG. 5 depicts a sectional view of FIG. 4 and shows batteries or a battery pack 327, a cable 360 connected to a board for electronics 325, an installation nut 350, an outer threated area 333 and a integrated antenna cover 305.

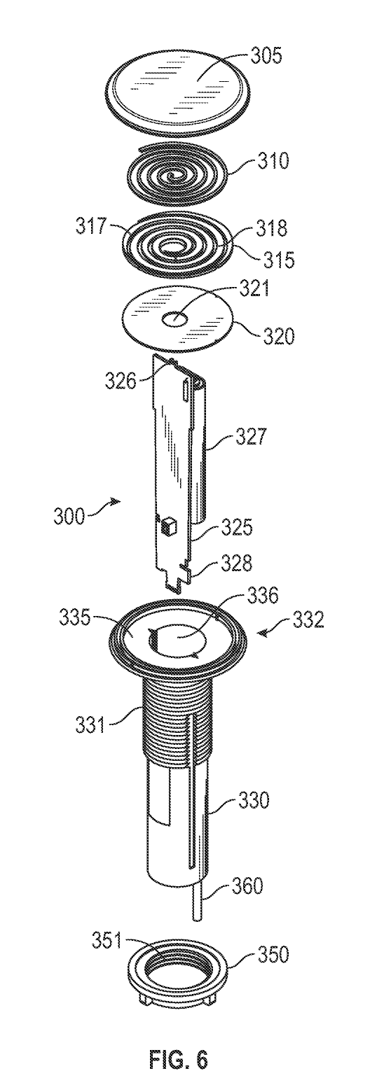

FIG. 6 depicts an exploded view of a disclosed transmitter assembly 300 or antenna system and comprises an installation nut 350 having internal female threads 351, a main housing 330 comprising a cable 360, an outer treaded area 331, a upper lip area 332 comprising an antenna support shelf 335 and a center void 336 defined by the antenna support shelf 336, an board for electronics 325 or electronics board comprising a horizontal index tab 328, a battery pack 327 and a connector 326 for the spiral antenna, a support disk defining a center void 321, an antenna insulator 315 comprising spiral protrusions 318 that define spiral voids 317, the spiral voids able to accept a spiral antenna. An integrated antenna cover 305 is shown superior to the spiral antenna 310.

FIG. 6 depicts the upper lip area 332 having protrusions complementary to the distal barrier and medial barrier of the integrated cover.

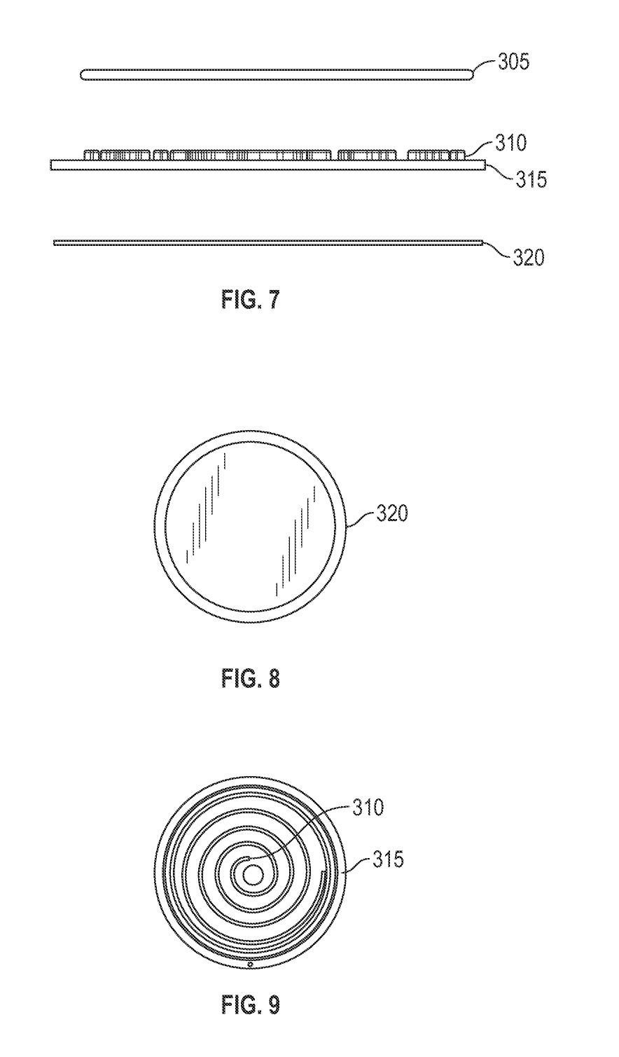

FIG. 7 depicts a sectional view or elevation view of several components that include an integrated antenna cover 305, an antenna insulator 315, insulating or otherwise covering a spiral antenna 310 and a support disk 320.

FIG. 8 depicts a plan view of a support disk 320.

FIG. 9 depicts a spiral antenna 310 entwined, embedded or protected by an antenna insulator 315.

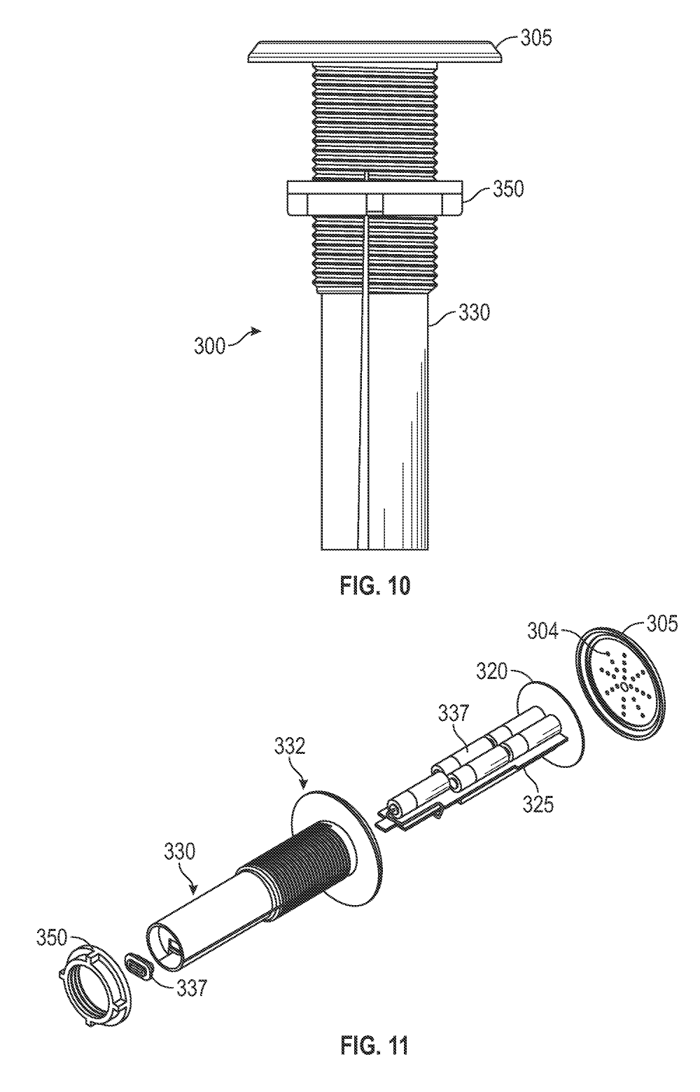

FIG. 10 depicts an assembled transmitter assembly 300 comprising a main housing 330, an installation nut 350 and an integrated antenna cover 305.

FIG. 11 depicts various components including an installation nut 350, a waterproof seal 337, an upper lip area 332, an electronics board 325 attached to a battery pack 327 and a support disk and an integrated antenna cover 306 shown with optional internal divots 304.

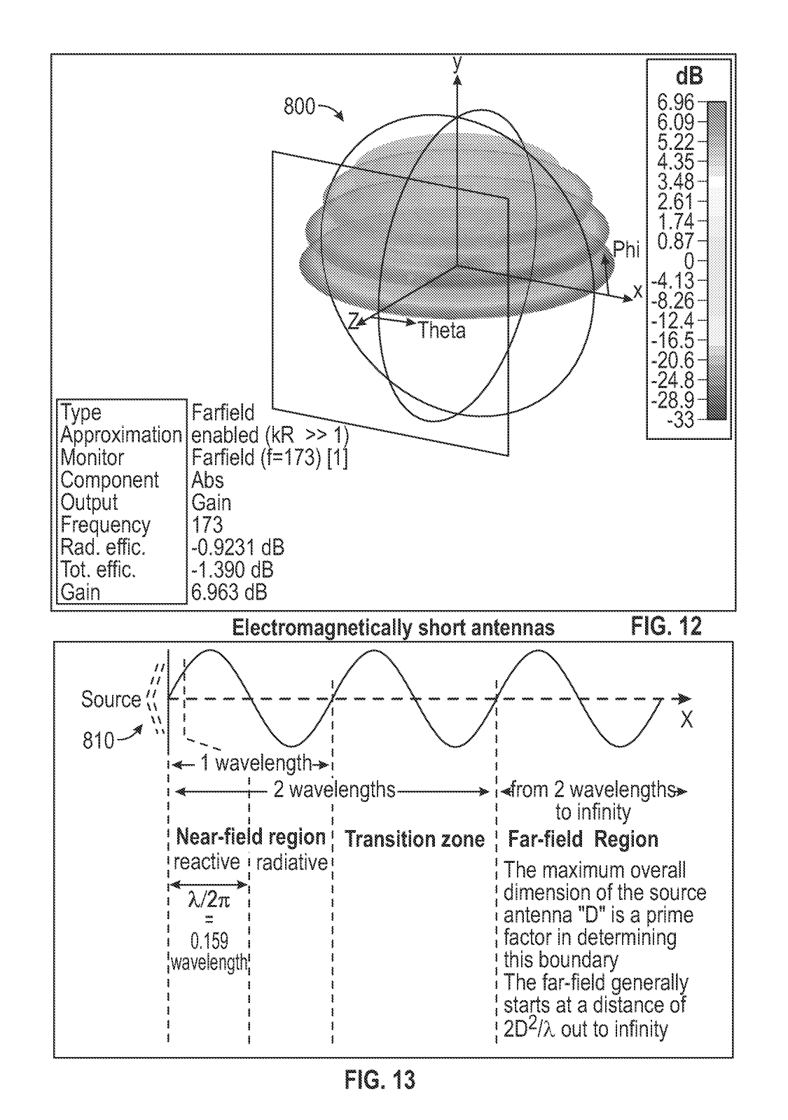

FIG. 12 depicts a perspective view of a disclosed RF transmission pattern 800.

FIG. 13 depicts a wave form 810 and other information regarding electromagnetically short antennas.

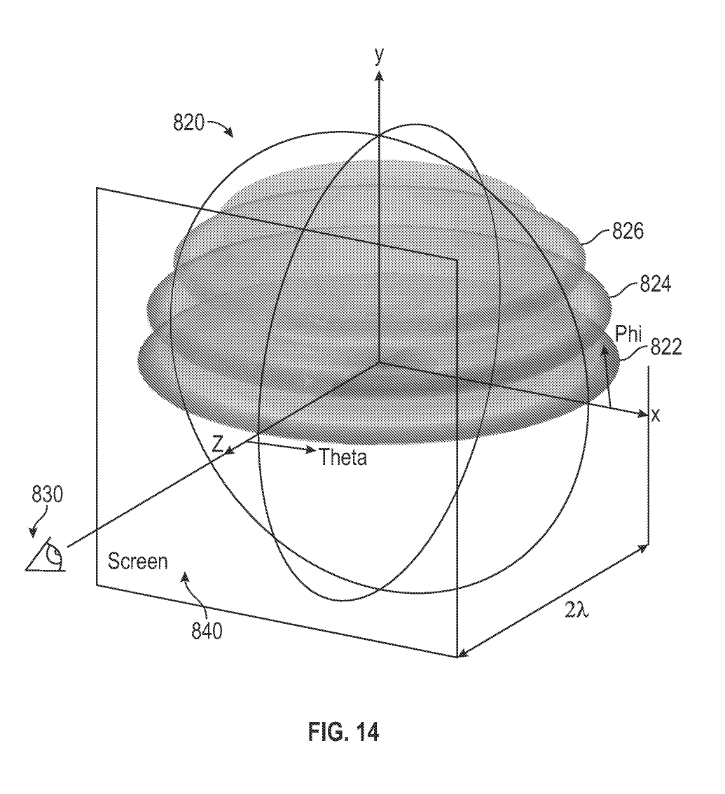

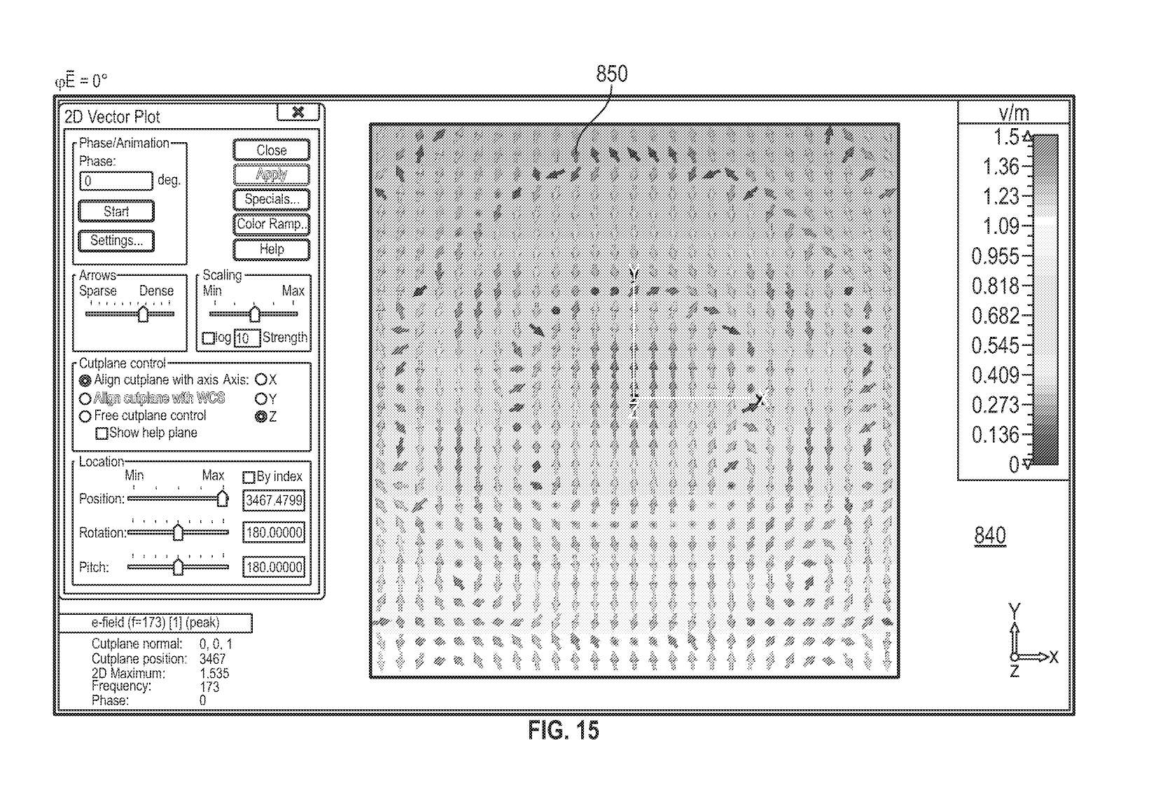

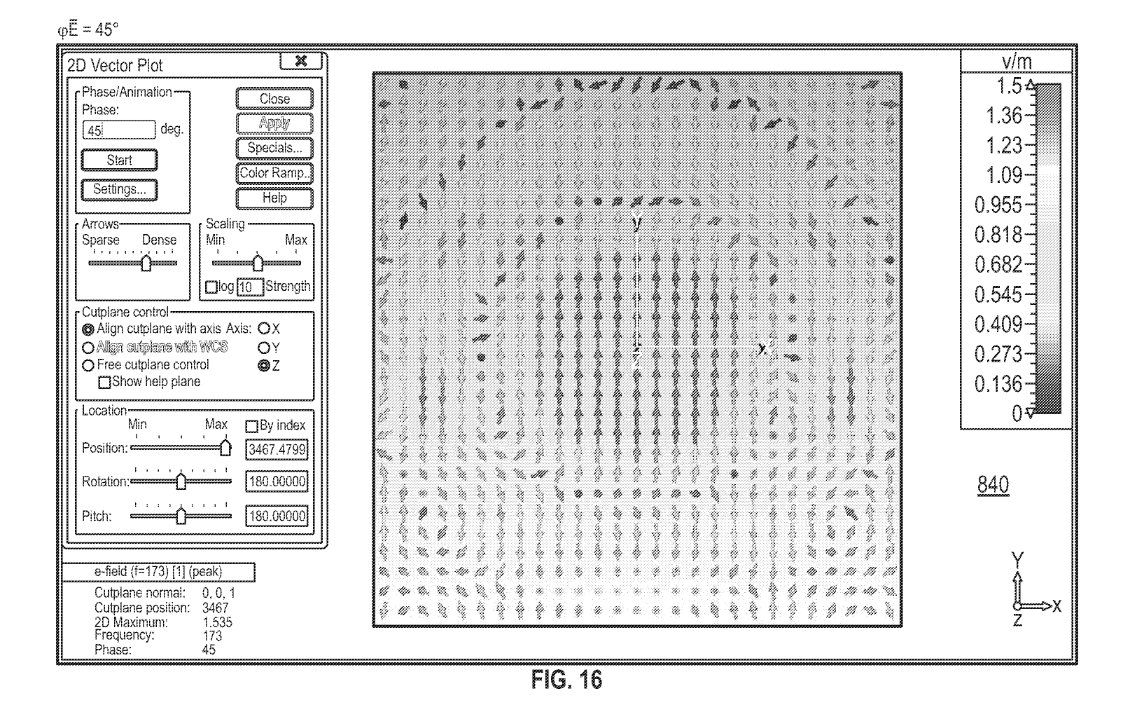

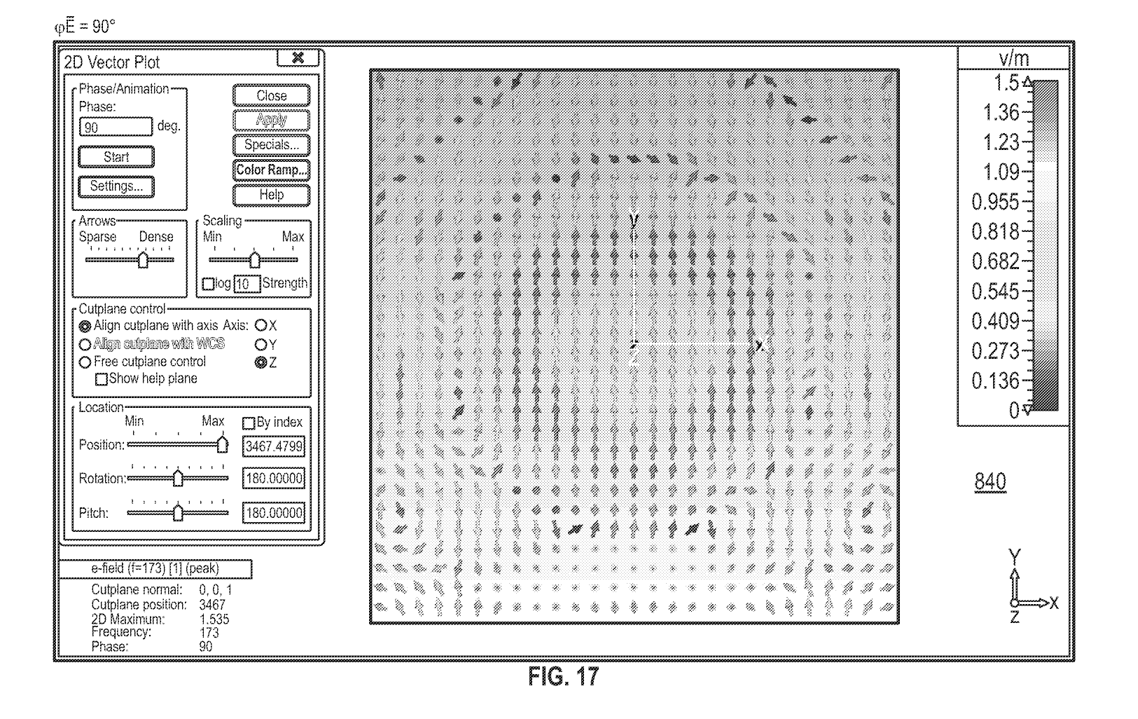

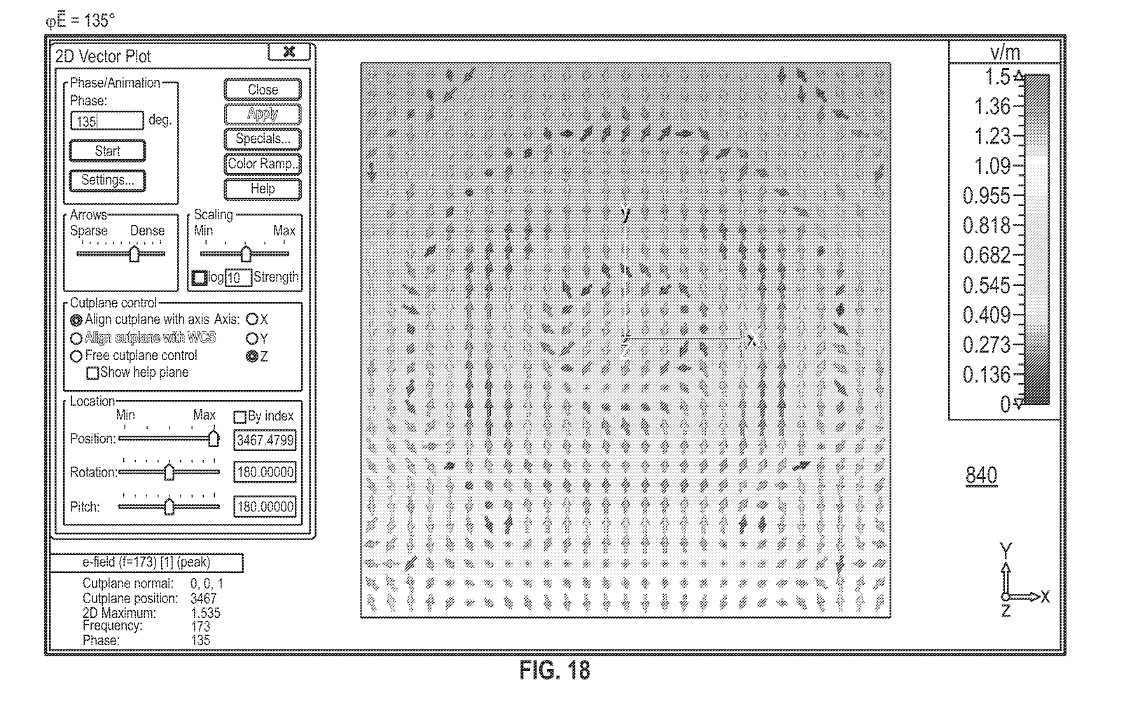

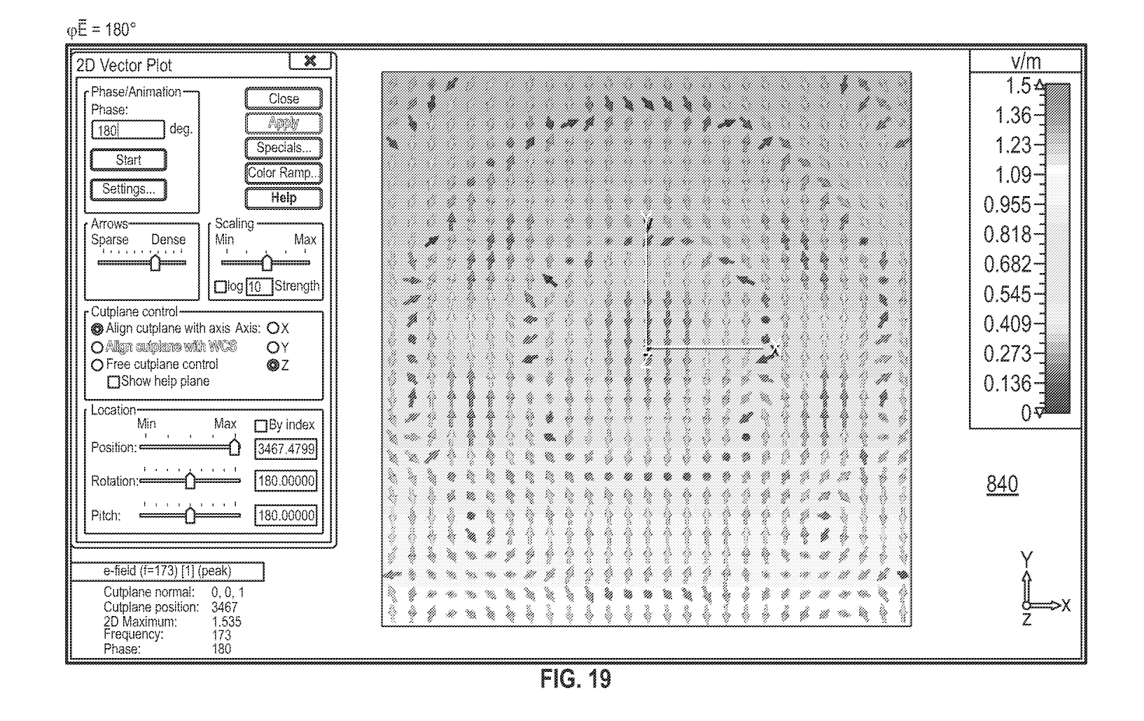

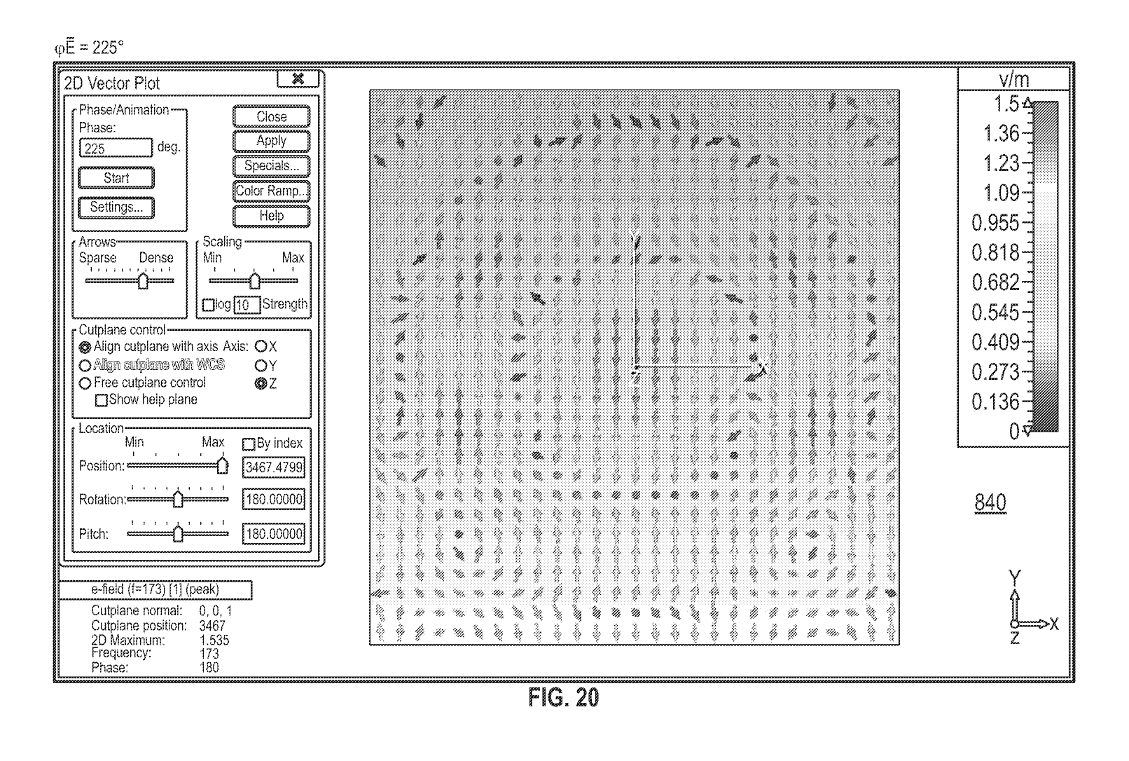

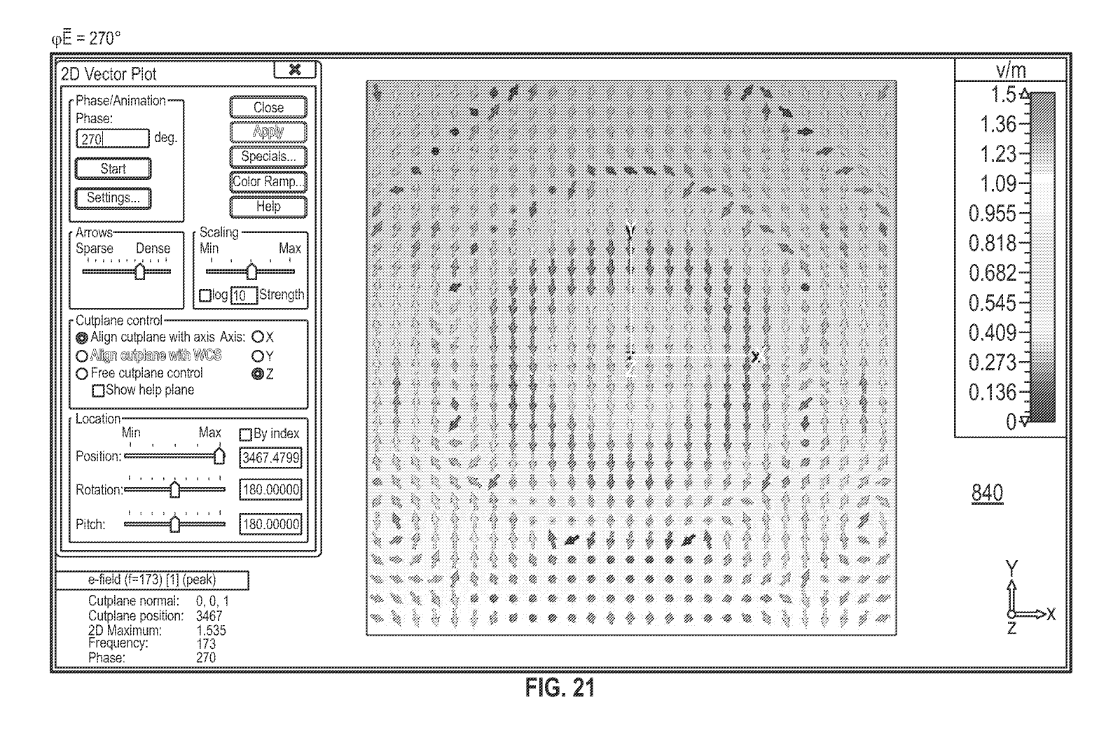

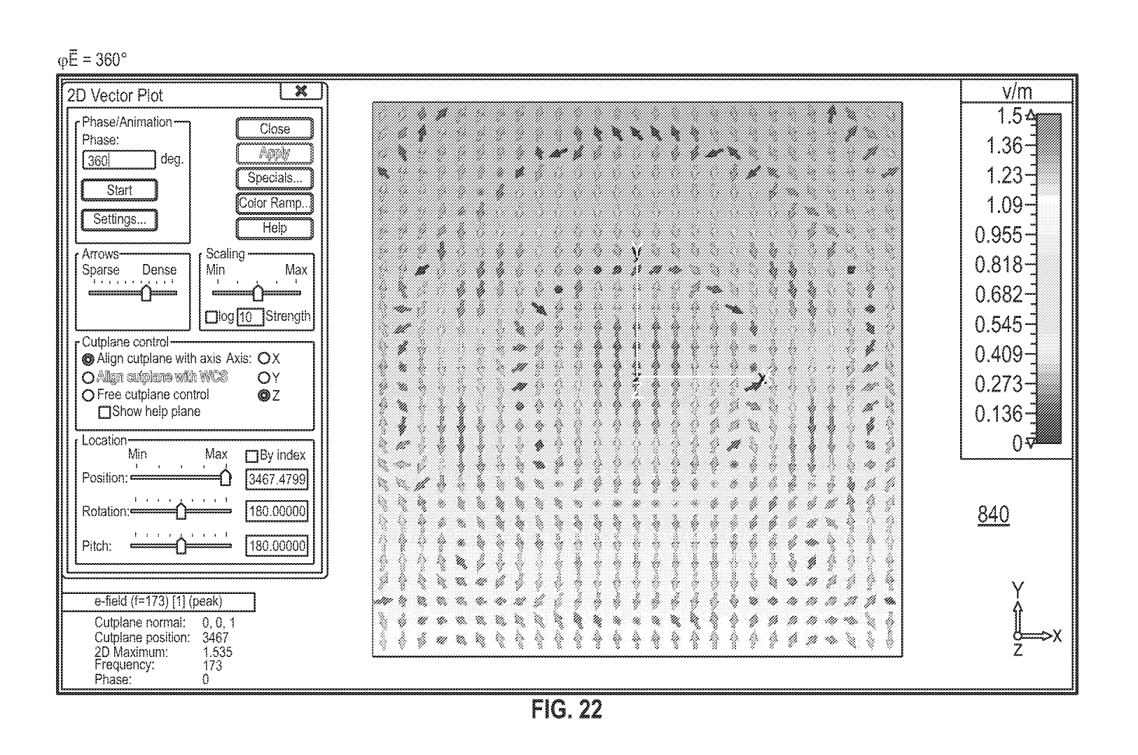

FIG. 14 depicts a perspective view of a disclosed circular polarization 820 of radio frequency. In one disclosed embodiment a polarization pattern or RF pattern may comprise a first 822, second 824 and third 826 concentric circle patterns. The system of three or more concentric circles of RF radiation provides new efficiencies in RF transmission. FIG. 14 depicts a display screen 840 or view port that is used in FIGS. 15 to 22.

FIG. 15 to FIG. 22 depicts 2D vector plots in phases of zero degrees to 360 degrees in increments of 45 degrees. Arrows 850 of RF direction are displayed upon a view port or two dimensional plane 840. In general FIG. 15 to FIG. 22 depict RF polarization as the locus traced by the extremity of the time varying field vector at a fixed observation point. The observation point distance may be in the range of 2λ to ∞. The RF polarization may vary depending upon the direction of radiation from an antenna. In some instances, a circularly polarized antenna may be approximately circular only over a narrow beam width, and linearly polarized away from the antenna's main beam.

The disclosed antenna system may comprise a spiral antenna 310 secured within an antenna insulator 315. The antenna insulator is made more efficient by use of spiral protrusions 318 that define spiral voids 317. A support disc 320 provides an effective barrier from the underlying transmitter assembly 300. The support disc 320 defines a center void 321 to accept a connector 326 for the antenna. The connector 326 transmits input from the transmitter assembly to the circular antenna. The disclosed configuration of a transmitter assembly 300, connector 326, antenna insulator, spiral antenna 310 and integrated antenna cover 305 help to ensure that RF transmissions are emitted from the spiral antenna only. The disclosed configuration helps to achieve the optimal RF patterns shown in FIG. 14 to FIG. 22.

The electronics board may include firmware, memory, a processor and other physical components to produce radio transmissions to convey meter readings to a receiver station and to receive radio transmissions or other information from a receiver station. As a receiver station may periodically query a plurality of disclosed meter reporting systems 100 and the receiver station may transmit an interrupt signal to a system causing the antenna system to stop a transmission. Such an interrupt signal is sent in the event that a meter reporting system is sending a message identical to a previous message. The ability of the disclosed meter reporting system to stop transmission when requested saves valuable battery power.

The ability of the integrated antenna cover 305 to fit with or into the top cover 205 of a pit housing 200 and an antenna insulator 315 and upper lip area 332 of a main housing allows the disclosed systems to be very efficient and cost effective. The disclosed configurations, which may include a distal barrier 307 and medial barrier 306 of an integrated antenna cover, allow for the artful placement of a spiral antenna 310 at the top of a pit housing. The top placement of the spiral antenna 310 allows a disclosed system to fit within a pit housing but yet provide superior radio transmission range and efficiency. The spiral antenna is protected by the pit housing and is thus not damaged by landscape maintenance.

The disclosed embodiments may include the following items:

Item 1. A spiral antenna emitting radio frequency (RF) radiation from spiral components only and emitting RF in the form of circular polarization only, the spiral antenna comprising a conductive member in the shape of a continuous concentric circle, the spiral antenna having a first end and a second end, with the first end in a most outward concentric circle and the second end positioned in the most inner concentric circle, with the second end defining an inner void.

Item 2. The spiral antenna of 1 encased in an antenna insulator 315, the antenna insulator comprised of spiral protrusions 318 with the spiral protrusions defining spiral voids 317, the spiral voids comporting to accept the spiral antenna.

Item 3. The spiral antenna of 2 wherein a support disk 320 is attached to a bottom side of the antenna insulator and an integrated antenna cover 305 is attached to a topside of the antenna insulator.

Item 4. The spiral antenna of 3 wherein the attached support disk defines a center void 321 and the center void contains a connector 326 for antenna and the connector for antenna is attached to a transmitter assembly 300.

Item 5. The spiral antenna of 4 wherein the transmitter assembly 300 comprises a board 325 for electronics and a battery pack 327 and wherein the transmitter assembly is enclosed within a main housing 330.

Item 6. The spiral antenna of 5 wherein the main housing is encased within a pit housing, the pit housing further containing a water meter.

Item 7. The spiral antenna of 6 wherein the water meter is electronically connected to the transmitter assembly.

Item 8. The method of RF emission, the method comprising the steps of:

using a spiral antenna shaped in the form of a continuous concentric circle;
using the spiral antenna only to transmit RF emissions; and
using the spiral antenna to transmit RF emissions of circular polarization only.

Item 9. The method of 8 further comprising the step of using the spiral antenna under a integrated antenna cover.

Item 10. The method of 9 further comprising the step of using the spiral antenna while the spiral antenna is contained within an antenna insulator 315.

Item 11. The method of 10 further comprising the step of using the spiral antenna within a pit housing with the pit housing containing a water meter.

Item 12. The method of 11 further comprising the step of using the spiral antenna to transmit RF emissions having the shape of three concentric circles, FIG. 14.

Item 13. A meter transmission system comprising:

a) a main housing 330 comprising: an installation nut 350, the installation nut comprising female threads 351, an outer threaded area 331 comporting to the female threads of the installation nut, a upper lip area 332 comprising a support shelf 335 defining a center void 336;
b) an electronics board 325 comprising a battery pack 327 and horizontal index tab 328, a cable 360 and a connector 326;
c) an upper antenna assembly comprising a support disk 320 defining a center void 321, an antenna insulator 315, the antenna insulator comprising spiral protrusions 318 defining spiral voids 317, a spiral antenna 310 configured to comport to the spiral voids of the antenna insulator and an integrated antenna cover 205, the integrated antenna cover comprising a distal barrier 307 and a medial barrier 306.

Item 14. The system of item 13 wherein the upper lip area of the main housing comprises protrusions complementary to the distal barrier and medial barrier of the integrated cover.

Item 15. The system of item 14 wherein a top cover 205 of a pit housing is attached to an integrated top cover.

Item 16. The system of item 15 wherein the cable is attached to a water meter.

Item 17. The system of item 16 wherein the electronics board reads a value from the water meter and transmits the value through the spiral antenna.

Item 18. The system of item 17 wherein the electronics board accepts a stop transmission message and stops transmission.

What is claimed is:

1. A spiral antenna emitting radio frequency (RF) radiation from spiral components only and emitting RF in the form of circular polarization only, the spiral antenna comprising a conductive member in the shape of a continuous concentric circle, the spiral antenna having a first end and a second end, with the first end in a most outward concentric circle and the second end positioned in the most inner concentric circle, with the second end defining an inner void.

2. The spiral antenna of claim 1 encased in an antenna insulator, the antenna insulator comprised of spiral protrusions with the spiral protrusions defining spiral voids, the spiral voids comporting to accept the spiral antenna.

3. The spiral antenna of claim 2 wherein a support disk is attached to a bottom side of the antenna insulator and an integrated antenna cover is attached to a topside of the antenna insulator.

4. The spiral antenna of claim 3 wherein the attached support disk defines a center void and the center void contains a connector for antenna and the connector for antenna is attached to a transmitter assembly.

5. The spiral antenna of claim 4 wherein the transmitter assembly comprises a board for electronics and a battery pack and wherein the transmitter assembly is enclosed within a main housing.

6. The spiral antenna of claim 5 wherein the main housing is encased within a pit housing, the pit housing further containing a water meter.

7. The spiral antenna of claim 6 wherein the water meter is electronically connected to the transmitter assembly.

8. A method of RF emission, the method comprising the steps of:
using a spiral antenna shaped in the form of a continuous concentric circle;
using the spiral antenna only to transmit RF emissions; and
using the spiral antenna to transmit RF emissions of circular polarization only.

9. The method of claim 8 further comprising the step of using the spiral antenna under an integrated antenna cover.

10. The method of claim 9 further comprising the step of using the spiral antenna while the spiral antenna is contained within an antenna insulator.

11. The method of claim 10 further comprising the step of using the spiral antenna within a pit housing with the pit housing containing a water meter.

12. The method of claim 11 further comprising the step of using the spiral antenna to transmit RF emissions having the shape of three concentric circles.

13. A meter transmission system comprising:
a) a main housing comprising: an installation nut, the installation nut comprising female threads, an outer threaded area comporting to the female threads of the installation nut, a upper lip area comprising a support shelf defining a center void;
b) an electronics board comprising a battery pack and horizontal index tab, a cable and a connector; and
c) an upper antenna assembly comprising a support disk defining a center void, an antenna insulator, the antenna insulator comprising spiral protrusions defining spiral voids, a spiral antenna configured to comport to the spiral voids of the antenna insulator and an integrated antenna cover, the integrated antenna cover comprising a distal barrier and a medial barrier.

14. The system of claim 13 wherein the upper lip area of the main housing comprises protrusions complementary to the distal barrier and medial barrier of the integrated cover.

15. The system of claim 14 wherein a top cover of a pit housing is attached to an integrated top cover.

16. The system of claim 15 wherein the cable is attached to a water meter.

17. The system of claim 16 wherein the electronics board reads a value from the water meter and transmits the value through the spiral antenna.

18. The system of claim 17 wherein the electronics board accepts a stop transmission message and stops transmission.
